(19) United States
(12) Patent Application Publication
(10) Pub. No.: US 2019/0197458 A1
(43) Pub. Date: Jun. 27, 2019

(54) SYSTEM AND METHOD FOR MAKING INTERACTIVE DECISIONS WITH INPUTS FROM SELECTED PARTICIPANTS

(71) Applicant: Darren C. Post, Clarkston, MI (US)

(72) Inventor: Darren C. Post, Clarkston, MI (US)

(21) Appl. No.: 16/233,506

(22) Filed: Dec. 27, 2018

Related U.S. Application Data
(60) Provisional application No. 62/610,725, filed on Dec. 27, 2017.

(51) Int. Cl. G06Q 10/06; G06F 16/34; G06F 16/25; G06Q 30/02

(52) U.S. Cl. CPC G06Q 10/063112; G06Q 30/0282; G06F 16/252; G06F 16/345

(57) ABSTRACT

A system and method to aid a user in making a decision. The system and method generally is provided within an application hosted on an electronic device though companion applications in the form of a user portal and advisor/expert portal. Accordingly, users are able to solicit an advisor/expert for counsel on a various decision though the input of criteria related to the decision, wherein the application will control correspondence between the parties and provide quantitative and qualitative tools to aid in the user's analysis. The application is generally hosted on a “cloud” and designed to enable effective communication between user's and advisers/experts.

### CROSS REFERENCE TO RELATED APPLICATIONS

This application claims priority to U.S. Provisional Patent Application No. 62/610,725 filed 27 Dec. 2017 to the above-named inventor, and is herein incorporated by reference in its entirety.

### FEDERALLY SPONSORED RESEARCH OR DEVELOPMENT

Not Applicable

### SEQUENCE LISTING, A TABLE, OR A COMPUTER PROGRAM

Not Applicable

### FIELD OF THE INVENTION

This invention relates generally to an improved system and method to aid a user in decision making. The system and method is generally hosted on an electronic device to enable collaboration between a decision maker and multiple advisors allowing the decision maker to select the best option for a particular decision. Further, the system and method of the present disclosure enables an efficient qualitative summary of inputs from multiple advisors and quantitative algorithms for consolidating these inputs to aid the decision maker in determining their best option for a given decision. Advisors are selected from a virtual marketplace or selected by the user from the user's personal network of associates. Advisors can sign up to participate in a virtual marketplace hosted by the system. This enables a new “free” market for any advice services whether business, education, public, and service, etc.

### BACKGROUND

Existing decision methods currently use one expert/advisor—one decision or a group of experts/advisors—one decision. These individuals or groups of experts consolidate their expertise and analysis to help recommend the best alternative or option for a given decision. In our personal lives, many individuals use a different model, wherein they get the advice of multiple people for important decisions. For example, if an individual's cardiologist recommended a heart transplant to resolve symptoms that they were experiencing, it is likely that they would seek a second or third opinion. Currently, this individual would be left to try to interpret multiple inputs qualitatively and try to make their best-informed decision. In today's world, it is difficult to engage multiple experts or people that one trusts to effectively or efficiently help in making decisions.

Companies, public organizations and individuals often engage a professional consulting firm to help with important decisions. These firms are paid a retainer and are the sole advisor on a given decision, often pitched to protect the consulting firm's proprietary decision methodologies. With the approach enabled by the system and method of the present disclosure, these companies would engage as many experts as they would like and focus them on specific decisions, rather than a rolling set of dialogues from a singular advisor. These consulting companies would then be rated on how well they provided decision specific input.

The system and method of the present disclosure fosters the shift from one advisor/consultant—one decision to multiple advisors—one decision. With multiple advisors engaged according to the system and method, decision quality is enabled to improve decision making by analyzing and interpreting criteria important to the problem and proposing options. Accordingly, if two or three consultants, using their own knowledge and tools provide similar option ratings and qualitative considerations, this would raise the decision maker's confidence in making the decision.

Therefore, there exists a need to improve the efficiency and cost of advice and counsel in the decision-making process through an integrated decision-making system and method. Preferably, this system and method is hosted on an electronic device or computing device and enables the collection of various inputs from multiple advisors to increase the veracity of a given decision analysis. The system and method can generally be hosted on a remote network and includes various reporting features related to various quantities and qualities of a given decision maker and user of the system and method.

### BRIEF SUMMARY OF THE INVENTION

In one aspect, this disclosure is related to a decision-making system and method to aid a decision maker in making a decision though a communicative portal hosted on an electronic device and within a given application.

In another aspect, this disclosure is related to a decision-making system and method that utilizes an application to connect users with advisors and experts in an efficient interface. Accordingly, the advisor/expert is able to communicate a given input on a decision back to a central database, preferably hosted on a “cloud” based network, to consolidate and calculate various parameters of a given decision. The application will utilize this advisor/expert input to generate decision reports to a given user to aid in making a decision.

In another aspect, this disclosure is related to application that allows a user to seek help and collaboration in making a decision from various contacts, acquaintances, and experts to provide the user with additional tools to aid in making the decision.

In another aspect, this disclosure is related to a decision marketplace hosted on an application and accessible through an electronic device, wherein various individuals and experts in a given area can utilize their expertise to provide a user with information and analysis related to a given decision. Accordingly, this service can be offered with or without a fee.

### BRIEF DESCRIPTION OF THE DRAWINGS

The accompanying drawings are included to provide a further understanding of the present invention and are incorporated in and constitute a part of this specification. The drawings illustrate exemplary embodiments of the present invention and together with the description serve to further explain the principles of the invention. Other aspects of the invention and the advantages of the invention will be better appreciated as they become better understood by reference to the Detailed Description when considered in conjunction with accompanying drawings, and wherein:

FIG. 1 is a wireframe diagram of the various system and communication pathways of the system and method, according to the present invention;

FIG. 2 is a flow chart of the method steps of the various system and communication pathways of a user and an adviser, according to the present invention; and

FIG. 3 is a general wireframe diagram of the adviser marketplace of the system and method, according to the present invention.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful, and is not intended to exclude other embodiments from the scope of the invention.

As used herein, the terms “front,” “back,” “rear,” “upper,” “lower,” “right,” and “left” in this description are merely used to identify the various elements as they are oriented in the FIGURES, with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature and/or such joining may allow for the flow of fluids, electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

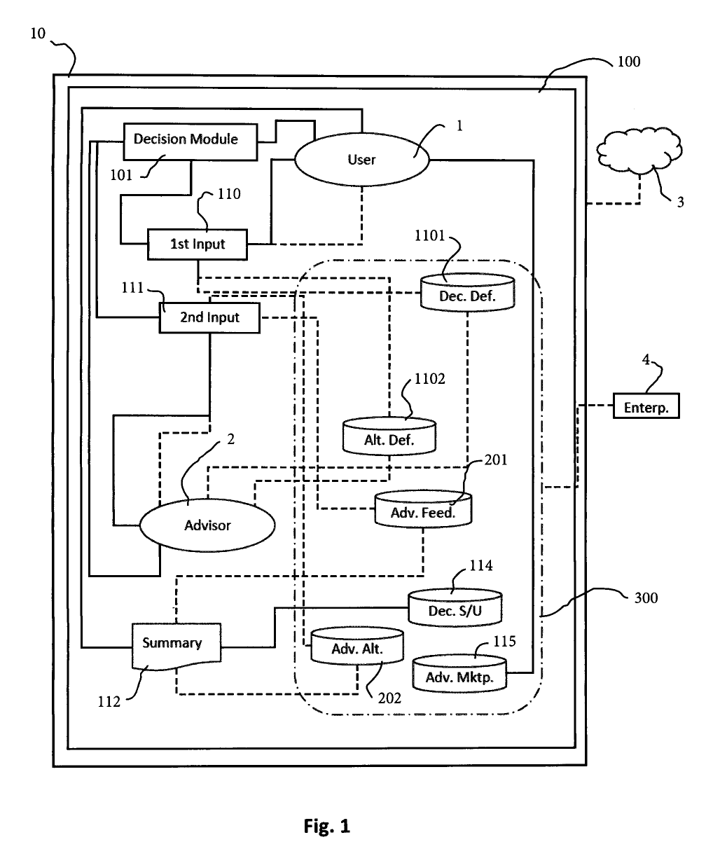

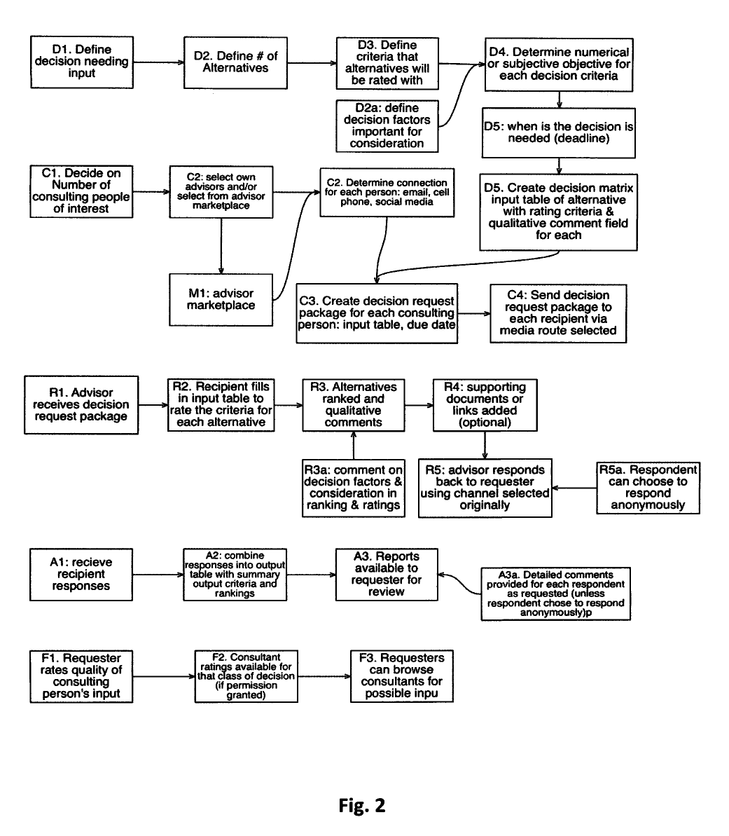

Referring now to FIGS. 1-3 of the decision-making system and method according to the present disclosure. Referring now to FIG. 1-2, in which, as illustrated, is the preferred configuration for a system 10 and method steps of making interactive decisions in accordance with the teaching of the present disclosure. The system 10 includes a decision module 101 hosted on a server 100 with the decision module 101 configured to receive a first input 110 in a first step by a user 1 of the system 10 and method in the form of a request related to decision. Accordingly, the user 1 enters a description of a decision within the first input 101 needing advising in step D1, through a keyed description by entering it into the first input 110 as displayed on a screen of a personal electronic device utilizing the system 10. This description of the decision is transmitted to a decision definition database 1101 for storage and later use by the advisor 2 in evaluation and the system 10 in compiling decision results.

At this first input 110 the user 1 may be prompted to enumerate alternatives to the decision needing advising at step D2 for consideration. These alternatives related to the decision of the user 1 are transmitted to an alternate definition database 1101 for storage and later use by the advisor 2 in evaluation and by the system 10 in compiling decision results. Within the first input 110 of the system 10 and method the user 1 will prompted with various questions related to the decision that include, but are not limited to the questions shown in FIG. 2. Accordingly, the user 1 may enter their decision criteria shown as step D2a in they first input 110 corresponding to their specific decision factors that are important for their consideration. Further, if alternatives are to be considered by the advisor 2 related to the user 1 decision, the user 1 at step D3 will define criteria that these alternatives will be rated with.

Additionally, within the first input 110 the user 1 will determine and select a numerical or subjective objective decision criteria at step D4 for use by the advisor 2, and when and if a specific date or deadline is needed for completion within step D5. After this data and information is received at the first input 110 and transmitted to the appropriate database 1101, 1102, the system 10 generates an input table at step D6 that will be used by the advisor 2 for evaluation.

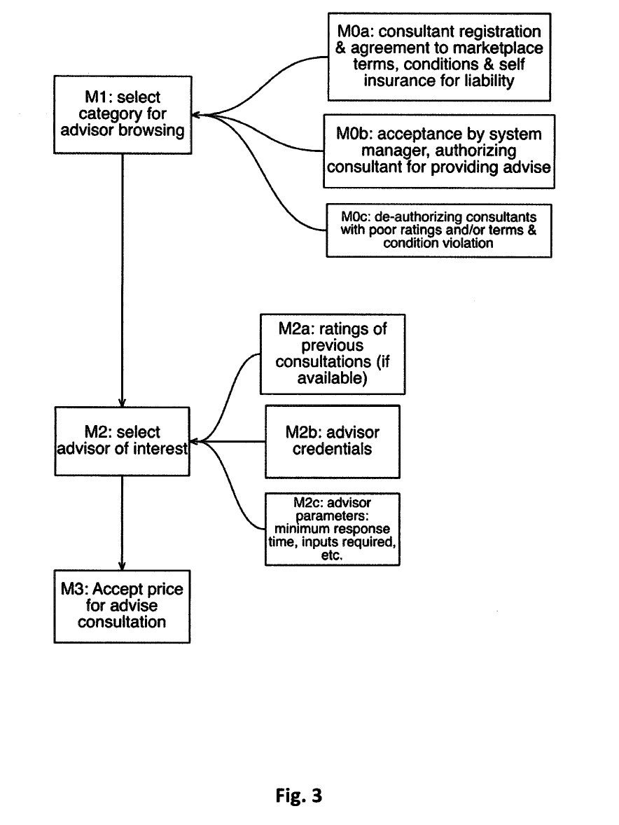

With the first input 110 the user 1 is able to further select from criteria related to the advisor 2 including but not limited to, the number of consulting people of interest or otherwise known herein as advisors 2 they would like utilized at step C1. Further at step C2, the user 1 may determine whether they would like to use a specific advisor 2 within their personal network or select an external advisor in an advisor marketplace, wherein they will be directed to the advisor marketplace at step M1 and shown in FIG. 3. Additionally, within step C2 the user 1 will select the preferred connection information, including, but not limited to, cell/mobile number, email, and social media address, that will be used to connect with a given advisor 2. At step C3, the system 10 generates a decision request package for each advisor 2 including the input table and due date that is then distributed to the advisor 2 at step C4 in the preferred media route selected by the user 1.

After information by the user 1 is completed at the first input 110, the selected advisor(s) 2 then receives a decision request package at step R1. Accordingly, a given advisor 2 will complete an assessment of the decision criteria based upon their knowledge and experience at step R2 for use by the system 10 at the second input 111. The advisor 2 provides feedback related to the decision in an assessment at the second input 111 that is communicated for storage to an advisor feedback database 201. If alternate decisions are requested as provided in method step R3, the advisor 2 will provide additional feedback in an assessment at the second input 111 that is communicated for storage in an advisor suggested alternatives database 202. Within the second input 111 the advisor may be prompted at steps R3, R3a, and R4 to provide information, including, but not limited to, rankings, comments, considerations, and optionally provide supporting documents or links. This advisor 2 feedback is transmitted from the relevant database 201, 202 for assembly by the system 10 into a summary 112 that is configured for compiling by the decision module 101 for communication to the user 1 for review and analysis at step A1. Prior to compiling, the advisor 2 may respond back to the user 1 with questions, feedback, or other items at step R5 and wherein the advisor 2 may do so anonymously at step R5a.

Advisor 2 feedback for use by the system 10 and decision module 101 compiling, including the alternatives, is presented on a table by ranking alternatives from 1 to n. Numerical criteria assessments and qualitative advantages (‘pros’) and disadvantages (‘cons’) are input at the second input 111 for each decision criteria to support the ranking rationale. Each decision criteria are assessed in the table that is provided as the summary 112 and communicated to a decision setup database 114 for assembly. For example, criteria may be assessed on a selected scale from 1 to 5 (1=low degree and 5=high degree), and quantitative assessments, such as fair market price or cost and probability of success, are entered as real numbers for later analysis. If the advisor decides to provide a range estimate for real numbers, such as cost $100-200, that may be accepted and used later. Qualitative ‘pro’ and ‘con’ assessments are provided to complement the criteria scale ratings input by the advisor 2 and to provide a logical context for the user 1. The advisor(s) 2 can add any suggested alternatives and revise ranking and enter criteria data.

Further, the advisor(s) 2 may provide a decision rationale for entry alongside each alternative to describe their individual ranking rationale at the second input 111. Each decision criteria are assessed in the table and provided in the summary 112. For example, numerical criteria parameters such as cost, price, and time are entered as real numbers for later analysis. If the advisor decides to provide a range, such as cost $100-200, that is accepted and used later. Qualitative criteria inputs are input by the advisor as well. Advisors can add then add any suggested alternatives and revise ranking and enter criteria data throughout their ranking process.

Once the advisor(s) 2 has completed the decision input at the second input 111, which may be in the format of a data table for improved organization, they will make a selection to indicate that their input is complete. Accordingly, the advisor 2 has an opportunity to attach any files that would help support any alternative assessment (step R4). Completion of the input, is configured by the system 10 to transmits the decision input table or summary 112 back to the user 1 through a network back to the user 1 at a device that originated the decision inquiry. Further, in the case of multiple advisors 2 once decision inputs are received from all advisors 2 at the second input 111 the information is collated by the decision module 101 of the system 10 in the summary 112 at step A2 wherein the information in the form of the summary 112 is presented to the user 1 at step A3, representing a decision analysis that helps the user 1 compare alternative rankings to aid in making an informed decision and wherein the summary 112 may include detailed comments and input at step A3a.

After receipt and review of the decision generated by the system 10. The user 1 may rate the advisor 2 based upon objective and subjective criteria at step F1. The system 10 may collate and aggregate various advisor 2 reviews over time for various decision types at step F2, and wherein the user 1 is able to browse advisors 1 for future decision making at step F3 with the advisor 2 reviews of the users 1 stored on system 10 within an advisor marketplace database 115.

The system 10 and method steps enables individuals or organizations to acquire decision-by-decision input from multiple advisors in order to select the best option for a particular decision. This is a significant change as the current industry approaches contracting consultants in exclusive arrangements to provide counsel on select decisions. Further, the system 10 and method enable expanded access to thousands of businesses who can't afford expert advice from high caliber organizations. The rating of advisors 2 features of the system 10 and method steps at F2-F3 enables the creation of a new breed of advisor firms and individuals, enabled by this disclosure.

The system 10 and method steps are configured to enable the efficient qualitative summary of inputs from advisors 2 or experts and provide a new quantitative method for consolidating advisor input to take the subjectivity out of comparisons by users 1.

The system 10 and method is preferably executed on a mobile device, such as a cellular telephone, through a software application (APP) configured to communicate the various decision parameters and options from users 1 to advisors 2 to enable a practical and efficient user-to-advisor interface. Advisors 2 may use the mobile device APP of the system 10 and method to communicate their input at the second input 111 back to a central server 100 that may be hosted on a cloud 3, wherein the system 10 is accessible across multiple computing platforms and devices. Accordingly, the system 10 database structures are configured for using a multipage spreadsheet or similar tool to consolidate and facilitate back room calculations and ratings of the system 10. The unique analytical method of the system 10 combines and “normalizes” these inputs and consolidates them appropriately; this removes the interpretation from the determination by a user 1 of which option or alternative is superior.

As is seen in FIG. 1-3, within the process of formulating a decision for evaluation by a user 1 of the system 10 and method of the present disclosure the user 1 may select a given advisor 2 from the advisor marketplace at step C2. Accordingly, the system 10 includes a marketplace (FIG. 3) providing various consultant types to sign up as the advisor 2 in a dedicated Advisor Marketplace portal of the advisor portion of the system 10 APP. The advisors 2 are enabled to categorize their expertise and cost per decision. Accordingly, the system 10 APP provides a fundamental change in how advice is provided by traditional advice-based industries to provide services directly to users 1. A given user 1 is in control, free to choose the right consultant they select for a given decision. Further, the Advisor Marketplace provides the user 1 a platform to rate the advisor 2 according to various criteria, including, but not limited to, the effectiveness, and the quality of service received. This rating is then utilized by additional users 1 for future services. Accordingly, this Advisor Marketplace enables a new “free” market for any advice services whether business, education, public service, etc. that today is generally operating under the antiquated retainer fee and single advisor model that is often not specific to any particular decision.

As is specifically shown in FIG. 3, the Advisor Marketplace of the system 10 includes various method steps to enable its features. At a first step M1, the user 1 is able to select a given category for a decision and enabled to browse for specific advisors 2 within the given category. Within this selection at M2, the user is able to view various elements related to the advisors 2, including but not limited to, previous ratings (if available) (M2a), credentials (M2b), minimum response time, input required, price, and various other items related to a given advisor 2 (M2c). The user 1 is then able to select the advisor 2 they would like to consult for their given decision at step M3.

Concurrent with advisor 2 selection by the user 1, the Advisor Marketplace enables a given consult to register as an advisor 2 for placement within the marketplace at step M0a. The advisor 1, will need to provide various information related to their expertise, including but not limited to, experience, certifications, education, specialties, knowledge, and consent to terms, conditions, and liability limitations. The system 10 may include system administration to accept and remove a given advisor 2 for placement within the Marketplace and removal from the Marketplace at steps M0b and M0c.

Similar to the Marketplace, the user 1 of the system 10 and method will utilize a user based portal generally through the first input 110 corresponding to portion of the APP of the system 10 and method to accesses and further processes their input for a given and requested decision into the summary report 112 that presents all qualitative inputs and does a quantitative consolidation using the “Maximum-Minimum Expected Value Utility” calculations that are described below.

The system 10 and method of the present disclosure will utilize back end processing on the server 100 that may include an algorithm to generally aid in the rating of options, generally referred to as the maximum-minimum expected value utility algorithm. The maximum-minimum expected value utility algorithm derives a marginal utility for option rating factors that are defined in the APP dialogue with the user 1 and gathered from the APP dialogue with multiple expert advisors 2 to enable a quantitative ranking of options for a given decision. The data is structured during the users 1 initial decision setup at the first input 110 and calculated within the decision module 101 utilizing parameters including, but not limited to, a criteria 1 rating, a criteria 2 rating through the user APP. The advisors 2 will rate these criteria, provide a fair market price or cost and probability of success using the advisor 2 portal of the APP.

For a given decision, each advisor's 2 option ratings are converted into an expected value (EV) option utility by dividing the criteria ratings (e.g. an integer from 1 to 5) and divided by the fair market price. The expected value is calculated by adding the advisors 2 option utilities together and multiplied by the probability of success. This establishes quantitative ratings that can be compared across numerous advisors 2 on the same basis.

Now that comparable quantitative ratings for each advisor 2 and for all options are available, the algorithm determines the minimum EV utility value for each option. The next step is to rank the options by minimum EV utility values. The maximum of these minimum EV utility values is thus the highest value option, followed by the next highest value. This method ranks the options by dominance established by the selected advisors 2 knowledge about the options and their assessment of how these options meets the user's decision needs.

Accordingly, the maximum-minimum expected value utility calculation within the utility is as follows:
EV option utility=probability of success X (option utility (a)+option utility (b)+ . . . Option utility (n))
Where Option utility (decision, advisor)=criteria (n)/fair market price
Minimum utility (option)=lowest value (EV option utility (option(a)) . . . EV option utility (option(n))
Rank options by maximum (minimum utility (option(a)) . . . option(n))
Highest max-min EV utilities is most desirable option and lowest is the least desirable option.

The EV max-min utility ranking summary is displayed on an APP screen, alongside all option qualitative pro's and con's in the summary 112 including raw inputs. This gives the user the best summary by providing qualitative and quantitative information for their decisions.

To improve the veracity and robustness of the system 10 and method steps, the system 10 and server 100 architecture may be configured to enable separate servers or systems for users 1 and advisors 2. Accordingly, one configuration may segregate the decision definition database 1101, the alternate decision definition database 1102, the advisor feedback database 201, the advisor alternate feed back database 202, the decision setup database 114, and the advisor marketplace database 115 on a separate server 300. This server 300 may be hosted on the cloud 3 or alternately may be part of an enterprise 4, wherein the data of the system 10 is controlled by a central system operator. Various alternate configurations for the system 10 and method steps may be utilized without departing from the spirit of the present disclosure.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) but that the invention will include all embodiments falling with the scope of the appended claims.

What is claimed is:

1. A system to aid a user of the system in making a decision, the system comprising:
a decision module executable by a processor configured to allow for a first input by the user and at least one second input by an adviser; and
a server comprising a central processing unit and a memory, the server hosting the decision module and programmed to:
receive from the user a defined decision criterion requiring advice in the first input;
transmit the user defined decision criteria to a decision definition database;
transmit the user defined decision criteria to the advisor;
receive from the advisor an advisor feedback in the at least one second input;
transmit the advisor feedback to an advisor feedback database;
execute a command to utilize an algorithm to rank feedback and provide a readable summary;
transmit the readable summary to the user;
receive from the user a decision and an advisor rating;
transmit the decision to a decision setup database; and
transmit the advisor rating to an advisor marketplace database.

2. A system as in claim 1, wherein the server is programmed to:
receive an alternative from the user in the first input;
transmit the alternative to an alternative definition database;
transmit the alternative to the advisor;
receive from the advisor an advisor suggested alternative in the at least one second input;
transmit the advisor suggested alternative to an advisor suggested alternatives database; and
execute a command to provide the advisor suggested alternative in the readable summary.

3. A system as in claim 2, wherein the system is provided in a cloud and accessible from a remote location.

4. A system as in claim 2, wherein the system is openly accessible to both the user and the advisor.

5. A system as in claim 4, wherein the advisor marketplace database, the decision definition database, the advisor feedback database, the decision setup database, the alternative definition database, and the advisor suggested alternative database are hosted on a second server and controlled by an enterprise.

6. A system as in claim 2, wherein the system is selectively closed and accessible only members of an enterprise.

7. A system as in claim 5, wherein the system is openly accessible to the user and selectively closed to the advisor.

8. A system as in claim 5, wherein the system is openly accessible to the user and selectively closed to the advisor, the system including a second enterprise, the second enterprise selective closure to the advisor.

9. A system to aid a user of the system in making a decision, the system comprising:
a first remote computing device having a memory and a processing unit, the first remote computing device accessible to the user and configured for generating a first input;
at least one second remote computing device having a memory and a processing unit, the at least one second remote computing device accessible to at least one advisor and configured for generating at least one second input;
a decision module executable by a processor configured to receive the first input by the user and the at least one second input by the adviser; and
a server comprising a central processing unit and a memory, the server hosting the decision module and programmed to:
receive from the user a defined decision criterion requiring advice in the first input;
transmit the user defined decision criteria to a decision definition database;
transmit the user defined decision criteria to the advisor;
receive from the advisor an advisor feedback in the at least one second input;
transmit the advisor feedback to an advisor feedback database;
execute a command to utilize an algorithm to rank feedback and provide a readable summary;
transmit the readable summary to the user;
receive from the user a decision and an advisor rating;
transmit the decision to a decision setup database; and
transmit the advisor rating to an advisor marketplace database.

10. A system as in claim 9, wherein the server is programmed to:
receive an alternative from the user in the first input;
transmit the alternative to an alternative definition database;
transmit the alternative to the advisor;
receive from the advisor an advisor suggested alternative in the at least one second input;
transmit the advisor suggested alternative to an advisor suggested alternatives database; and
execute a command to provide the advisor suggested alternative in the readable summary.

11. A system as in claim 10, wherein the system is provided in a cloud and accessible from a remote location.

12. A system as in claim 10, wherein the system is openly accessible to both the user and the advisor.

13. A system as in claim 12, wherein the advisor marketplace database, the decision definition database, the advisor feedback database, the decision setup database, the alternative definition database, and the advisor suggested alternative database are hosted on a second server and controlled by an enterprise.

14. A system as in claim 10, wherein the system is selectively closed and accessible only members of an enterprise.

15. A system as in claim 13, wherein the system is openly accessible to the user and selectively closed to the advisor.

16. A system as in claim 13, wherein the system is openly accessible to the user and selectively closed to the advisor, the system including a second enterprise, the second enterprise selective closure to the advisor.

17. A method to enable collaboration between a decision maker utilizing a first electronic device and an at least one expert/advisor utilizing an at least one second electronic device, the method hosted on a server and including the steps of:
collecting an input from the electronic device of the user on the server, the input including:
a definition of a criteria for the decision;
a definition of a deadline; and
a definition of an objective of the decision;
selecting the preferred advisor by the user on the first electronic device within an advisor marketplace on the server;
receiving and consolidating an input on the server from the at least one second electronic device of the at least one expert/advisor;
presenting on the server a consolidated qualitative and a quantitative summary of a response from the at least one expert/advisor for display on the first electronic device of the user, wherein the quantitative summary utilizes an expected value utility calculation; and
receiving on the sever a rating the expert/advisor from the first electronic device of the user.

18. A method as in claim 17, wherein the first electronic device is a mobile phone.

19. A method as in claim 18, wherein the at least one second electronic device is a mobile phone.

20. A method as in claim 17, wherein the input includes an alternate decision criterion.
